(19) United States
(12) Patent Application Publication
(10) Pub. No.: US 2023/0398899 A1
(43) Pub. Date: Dec. 14, 2023

(54) POWER CONTROL DEVICE AND VEHICLE HAVING THE SAME

(71) Applicants: HYUNDAI MOTOR COMPANY, Seoul (KR); KIA CORPORATION, Seoul (KR)

(72) Inventor: Mun Soon KWON, Yongin-si (KR)

(73) Assignees: Hyundai Motor Company, Seoul (KR); KIA CORPORATION, Seoul (KR)

(21) Appl. No.: 18/080,338

(22) Filed: Dec. 13, 2022

(30) Foreign Application Priority Data
May 20, 2022 (KR) 10-2022-0061897

(51) Int. Cl. B60L 58/10; B60L 3/12; B60L 1/02; H02J 7/00

(52) U.S. Cl. CPC B60L 58/10; B60L 3/12; B60L 1/02; H02J 7/0047

(57) ABSTRACT

The vehicle includes a battery, a load receive a voltage higher than or equal to a preset voltage from the battery, a controller controls an operation of the load, a battery management system monitors a total amount of power output from the battery, and a power control device determines whether peak power is generated based on the total amount of power and an amount of peak power, controls the load so that an output of the load is decreased when it is determined that the peak power has been generated, and controls the load so that the output of the load is increased when it is determined that the generation of the peak power has been released.

### CROSS-REFERENCE TO RELATED APPLICATION

This application claims the benefit of Korean Patent Application No. 10-2022-0061897, filed on May 20, 2022 in the Korean Intellectual Property Office, the disclosure of which is incorporated herein by reference.

### TECHNICAL FIELD

Embodiments of the present disclosure relate to a power control device configured to distribute and control power by changing an output of a load, and a vehicle having the same.

### BACKGROUND

Vehicles are a machine configured to travel by driving wheels for the purpose of transporting persons or cargo and refer to a movement means or a transportation means which moves on a road.

In order to protect passengers and provide convenience and fun to the passengers, the vehicles include various electronic components, a battery configured to supply power to the electronic components, and a generator configured to generate power and supply the generated power to the electronic components and the battery.

The electronic components of the vehicle may be classified into high-power electronic components requiring a high voltage, such as an electric steering device, an electric compressor, and an air-conditioning heater, and low-power electronic components requiring a low voltage, such as a seat heating wire and a seat ventilation device.

Since the high-power electronic components consume a lot of power for a short time, voltages supplied to some electronic components may rapidly decrease, resulting in a low voltage problem. In other words, a problem in which operations of some electronic components are stopped may occur.

Conventionally, when a fault occurs in the electronic components or drive devices, it is not possible to determine whether the cause of the fault is a fault by the power supply or a fault of the electronic component itself.

In addition, there is a problem in that the occurrence of faults of the drive devices, such as an engine device, a transmission device, a braking device, and a steering device, and the electronic components directly associated therewith may lead to accidents.

### SUMMARY

Therefore, it is an aspect of the present disclosure to provide a power control device configured to decrease an output of a high-voltage load when peak power is generated and return the output of the high-voltage load to a certain output or increase the output of the high-voltage load when a certain time elapses and a vehicle having the same.

Additional aspects of the disclosure will be set forth in part in the description which follows and, in part, will be obvious from the description, or may be learned by practice of the disclosure.

In accordance with one aspect of the present disclosure, a power control device includes a communicator configured to communicate with a battery management system configured to manage a total amount of power output from a battery and a processor configured to receive the total amount of power through the communication unit, determine whether peak power is generated based on the received total amount of power and an amount of the peak power, and control an output of a high-voltage load based on whether the peak power is generated.

The processor of the power control device according to one aspect may in response to determination that the peak power is generated, control the high-voltage load so that the output of the high-voltage load is decreased, and in response to determination that the generation of the peak power is released, control the high-voltage load so that the output of the high-voltage load is increased.

The processor of the power control device according to one aspect may acquire a decrease of the output of the high-voltage load based on a difference between the received total amount of power and the amount of the peak power, control the output of the high-voltage load to be decreased based on the acquired decrease in the output, acquire the decrease in the output of the high-voltage load based on the difference between the received total amount of power and the amount of peak power, and control the output of the high-voltage load to be decreased based on the acquired decrease in the output.

The processor of the power control device according to one aspect may acquire an increase in the output corresponding to the acquired decrease in the output, and control the output of the high-voltage load to be increased based on the acquired increase in the output.

The processor of the power control device according to one aspect may acquire a target amount of output of the high-voltage load for each traveling time based on operation information of the high-voltage load received through the communication unit, acquire a target amount of power of the high-voltage load for each traveling time corresponding to the acquired target amount of output for each traveling time, acquire a default amount of power of the high-voltage load for each traveling time based on a traveling speed received through the communication unit, and acquire a reference time for output decrease control of the high-voltage load based on the acquired target amount of power for each traveling time and the acquired default amount of power for each traveling time.

The processor of the power control device according to one aspect may confirm the amount of the peak power corresponding to the traveling speed received through the communication unit.

The processor of the power control device according to one aspect may control the high-voltage load so that the output of the high-voltage load is increased based on the acquired reference time.

The high-voltage load in the power control device according to one aspect may include at least one of a compressor of a heating/ventilation/air conditioning (HVAC) device or a heater of the HVAC device.

In accordance with another aspect of the present disclosure, a power control device includes a communicator and a processor configured to acquire a target amount of output of a high-voltage load for each traveling time based on operation information of the high-voltage load received through the communication unit, acquire a target amount of power for each traveling time corresponding to the acquired target amount of output for each traveling time, confirm an amount of peak power corresponding to a traveling speed received through the communicator and a default amount of power for each traveling time, predict a total amount of power based on the target amount of power for each traveling time and the default amount of power for each traveling time, determine whether the peak power is generated based on the predicted total amount of power and the confirmed amount of peak power, in response to determination that the peak power is generated, control the high-voltage load so that an output of the high-voltage load is decreased, and in response to determination that generation of the peak power is released, control the high-voltage load so that the output of the high-voltage load is increased.

The processor of the power control device according to another aspect may acquire a first reference time and a second reference time based on the predicted total amount of power for each traveling time and the confirmed amount of peak power, control the high-voltage load so that the output of the high-voltage load is decreased for the first reference time, and control the high-voltage load so that the output of the high-voltage load reaches a target output for the second reference time when the first reference time elapses.

The processor of the power control device according to another aspect may control the high-voltage load so that the output of the high-voltage load is increased for the first reference time when the second reference time elapses.

The processor of the power control device according to another aspect may confirm the total amount of power at a time point when the peak power is generated, acquire a decrease in the output of the high-voltage load based on a difference between the confirmed total amount of power and the amount of peak power, and control the output of the high-voltage load to be decreased based on the acquired decrease in the output.

The processor of the power control device according to another aspect may acquire an increase in the output corresponding to the acquired decrease in the output, and control the output of the high-voltage load to be increased based on the acquired increase in the output.

The processor of the power control device according to another aspect may confirm a time period in which the predicted total amount of power for each traveling time is smaller than a reference amount of power, acquire the confirmed time period as an increase control section, and control the high-voltage load so that the output of the high-voltage load is increased in the increase control section.

The processor of the power control device according to another aspect may confirm a number of time periods in which the predicted total amount of power for each traveling time is smaller than the reference amount of power, and control the high-voltage load so that the output of the high-voltage load is increased based on the confirmed number of time periods and the acquired increase in the output.

The processor of the power control device according to another aspect may confirm a time for which the predicted total amount of power is maintained to be greater than or equal to the amount of peak power, and determine that the peak power is generated when the confirmed time is longer than or equal to a preset time.

In accordance with still another aspect of the present disclosure, a vehicle includes a battery, a load configured to receive a voltage higher than or equal to a preset voltage from the battery, a controller configured to control an operation of the load, a battery management system configured to monitor a total amount of power output from the battery, and a power control device configured to determine whether peak power is generated based on the total amount of power and an amount of the peak power of the load, transmit output decrease control information of the load to the controller in response to determination that the peak power has been generated, and transmit output increase control information of the load to the controller in response to determination that generation of the peak power is released.

The power control device of the vehicle according to still another aspect may acquire a decrease and an increase in the output of the load based on a difference between the total amount of power and the amount of peak power, and transmit the acquired decrease and increase in the output to the controller.

The vehicle according to still another aspect may further include a speed sensor detecting a traveling speed and an input device. The power control device of vehicle according to still another aspect may acquire a target amount of output of the load for each traveling time based on operation information of the load received in the input device, acquire the target amount of power of the load for each traveling time corresponding to the acquired target amount of output for each traveling time, acquire a default amount of power for each traveling time based on the traveling speed, and acquire a reference time when the output of the load is controlled based on the acquired target amount of power for each traveling time and the acquired default amount of power for each traveling time.

The power control device of vehicle according to still another aspect may predict the total amount of power for each traveling time based on the acquired target amount of power for each traveling time and the acquired default amount of power for each traveling time, confirm a time period in which the predicted total amount of power for each traveling time is smaller than a reference amount of power, acquire the confirmed time period as an increase control section, and transmit information on the increase control section to the controller.

The power control device of vehicle according to still another aspect may confirm a number of time periods in which the predicted total amount of power for each traveling time is smaller than the reference amount of power, and transmit the confirmed number of time periods and information on the acquired increase in the output to the controller.

### BRIEF DESCRIPTION OF THE DRAWINGS

These and/or other aspects of the disclosure will become apparent and more readily appreciated from the following description of the embodiments, taken in conjunction with the accompanying drawings of which:

FIG. 1 is an exemplary view showing an interior of a vehicle according to an embodiment;

FIG. 2 is a control configuration diagram of the vehicle according to the embodiment;

FIG. 3A is a graph showing an amount of power consumed by a drive motor over a traveling time and an amount of power consumed by a first load;

FIG. 3B is a graph showing an amount of power of the entire vehicle over the traveling time;

FIG. 4 is a graph of the amount of power of the entire vehicle according to the embodiment;

FIG. 5A is a graph for a target amount of output of the first load over time;

FIG. 5B is a graph for the total amount of power of the vehicle and the amount of power of the first load over time;

FIG. 6A is an exemplary view showing acquiring a decrease and an increase in the output of the first load provided in the vehicle according to the embodiment;

FIG. 6B is an exemplary view showing acquiring the decrease and the increase in the output of the first load provided in the vehicle according to the embodiment;

FIG. 7 is an exemplary view showing acquiring an output control time point of the first load provided in the vehicle according to the embodiment;

FIG. 8 is an exemplary view showing acquiring the output control time point of the first load provided in the vehicle according to the embodiment;

FIG. 9A is a graph of an amount of consumable power per unit time consumed in the vehicle according to the embodiment;

FIG. 9B is a graph of a charged amount of a battery responding to a change in the amount of power to be consumed per unit time consumed in the vehicle according to the embodiment;

FIG. 10 is a control flowchart of a power control device provided in the vehicle according to the embodiment;

FIG. 11A is a graph of the output control and total amount of power of the first load through the power control device according to the embodiment;

FIG. 11B is a graph of the output control and total amount of power of the first load through the power control device according to the embodiment;

FIG. 11C is a graph of the output control and total amount of power of the first load through the power control device according to the embodiment;

FIG. 12A is a graph of the output control and total amount of power of the first load through the power control device according to the embodiment;

FIG. 12B is a graph of the output control and total amount of power of the first load through the power control device according to the embodiment;

FIG. 12C is a graph of the output control and total amount of power of the first load through the power control device according to the embodiment;

FIG. 13A is a graph of the output control and total amount of power of the first load through the power control device according to the embodiment;

FIG. 13B is a graph of the output control and total amount of power of the first load through the power control device according to the embodiment; and

FIG. 13C is a graph of the output control and total amount of power of the first load through the power control device according to the embodiment.

### DETAILED DESCRIPTION

The same reference numerals refer to the same components throughout the specification. The specification does not describe all elements of the embodiments, and general contents in the art to which the present disclosure pertains or overlapping contents among the embodiments will be omitted. Terms “unit and device” used in the specification may be implemented in software or hardware, and according to the embodiments, a plurality of “units and devices” may be implemented as one component or one “unit and device” may also include a plurality of components.

Throughout the specification, when a certain portion is described as being “connected” to another portion, it includes not only a case in which the certain portion is directly connected to another portion but also a case in which it is indirectly connected thereto, and the indirect connection includes a connection through a wireless communication network.

In addition, when a certain portion is described as “including” a certain component, it means that other components may be further included, rather than excluding the other components unless otherwise stated.

Terms such as first and second are used to distinguish one component from another, and the components are not limited by the above-described terms.

The singular expression includes the plural expression unless the context clearly dictates otherwise.

In each operation, identification signs are used for convenience of description, and the identification signs do not describe the order of each operation, and each operation may be performed differently from the specified order unless the context clearly states the specific order.

Hereinafter, an operating principle and embodiments of the present disclosure will be described with reference to the accompanying drawings.

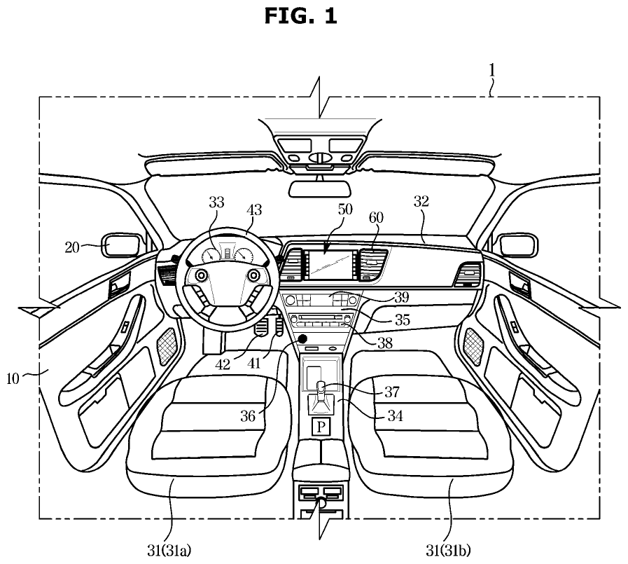

FIG. 1 is an exemplary view showing an interior of a vehicle according to an embodiment.

The vehicle in the embodiment may be an eco-friendly vehicle which travels with electricity as power to improve fuel efficiency and decrease harmful gas emissions.

The eco-friendly vehicle includes an electric vehicle including a rechargeable battery and a motor and configured to rotate the motor with electricity accumulated in the battery and drive wheels using the rotation of the motor and a hybrid electric vehicle including an engine, the battery, and the motor and configured to travel by controlling mechanical power of the engine and electrical power of the motor, and a hydrogen fuel cell vehicle.

In the embodiment, the electric vehicle will be described as an example.

A vehicle 1 includes a body having an exterior and an interior and a chassis configured to support the body and on which mechanical devices required for traveling are installed as the remaining portion except for the body.

The exterior of the body includes a front panel, a bonnet, a roof panel, a rear panel, front, rear, left, and right doors 10, and window glasses provided on the front, rear, left, and right doors 10 to be opened and closed.

The exterior of the body includes a side mirror 20 configured to provide a driver with a rear view of the vehicle 1 and a lamp configured to make it easy to see surrounding information while keeping eyes on a front view and perform a function of a signal or communication for other vehicles and pedestrians.

As shown in FIG. 1, the interior of the body includes seats 31 (31a and 31b) on which passengers sit, a dashboard 32, a cluster 33 disposed on the dashboard 32 and on which a tachometer, a speedometer, a coolant thermometer, a fuel gauge, a direction turning indicator lamp, a high beam indicator lamp, a warning lamp, a safety belt warning lamp, an odometer, a shift lever indicator lamp, a door open warning lamp, an engine oil warning lamp, and a low fuel warning lamp are disposed, a center fascia 34 on which a ventilator and a control plate of a heating/ventilation/air conditioning (HVAC) device are disposed, a head unit 35 provided on the center fascia and configured to receive an operation command of the electronic component, such as an audio device and the HVAC, and a start button 36 (or referred to as a “booting button”) provided on the center fascia and configured to receive a start command.

The cluster 33 may include a display panel and display information on first and second batteries and information on a power mode in response to a control command of a power management device 200.

The vehicle 1 may further include a shift lever 37 provided on the center fascia 34 and configured to receive an operation position and a parking button (an electronic parking brake (EPB) button) positioned around the shift lever 37 or on the head unit 35 and configured to receive an operation command of the EPB device (not shown).

The head unit 35 may include an input device 38 configured to receive a command from a passenger inside the vehicle 1 and a display device 39 configured to display information of the vehicle. The input device may include hardware devices, such as various buttons, a switch, a pedal, a keyboard, a mouse, a track-ball, various levers, a handle, a stick, and the like.

The head unit 35 may also include a graphical user interface (GUI), such as a touch pad, that is, a software device. The touch pad may be implemented as a touch screen panel (TSP) to form a layered structure with a display, and may also be provided independently of the head unit 35.

The head unit 35 may be connected to a plurality of controllers and may transmit received operation ON/OFF commands and operation information to at least one controller.

At least one controller may be a controller configured to control electronic components.

The vehicle includes an accelerator pedal 41 pressed by a user according to the user's acceleration intention, a brake pedal 42 pressed by the user according to the user's braking intention, and a steering wheel 43 of a steering device configured to adjust a traveling direction.

The vehicle 1 may include various electronic components for the control of the vehicle 1 and the safety and convenience of passengers.

For example, the electronic components may include an audio/video/navigation (AVN) device 50 (or a vehicle terminal) configured to provide the driver with various information and entertainments through sounds and images, a heating/ventilation/air conditioning (HVAC) 60 configured to control the air introduced from the outside of the vehicle or heat or cool inside air according to an indoor temperature of the vehicle 1, a door lock device, a wiper, a power seat, a seat heating wire, a seat ventilation device, a heating wire of a steering wheel, an indoor lamp, and a power tailgate.

The HVAC 60 may include an air-conditioning heater (or radiator) configured to generate heat and include an air-conditioning compressor configured to compress refrigerant.

Various electronic components may be loads configured to receive power and perform predetermined functions while consuming the received power.

The loads may be classified into a high-voltage load using a voltage higher than or equal to a preset voltage and a low-voltage load using a voltage lower than the preset voltage. For example, the high-voltage load includes the air-conditioning compressor, the air-conditioning heater, and the like, and the low-voltage load includes the seat heating wire, the heating wire of the steering wheel, the seat ventilation device, a cooling fan, and the like.

The electronic components may communicate with each other through a vehicle communication network (NT). For example, the electronic components may exchange data through an Ethernet, a media oriented systems transport (MOST), a Flexray, a controller area network (CAN), a local interconnect network (LIN), or the like.

The chassis may be provided with wheels disposed each of front, rear, left, and right sides, a power device 100 configured to apply a driving force to the front, rear, left, and right wheels, a steering device, a braking device configured to a braking force to the front, rear, left, and right wheels, and a suspension device.

The steering device may adopt a motor drive power steering (MDPS) method using a rotational force of a steering motor and include an electronic control device configured to control the steering motor.

The power device is a device configured to generate the driving force required for traveling the vehicle and adjust the generated driving force.

The power device may include a first battery, a drive motor, an inverter, a reducer, and a charging controller.

The first battery may include a plurality of battery cells configured to generate a high-voltage current and supply the driving force to the vehicle.

The drive motor generates a rotational force using electrical energy of the first battery and transmits the generated rotational force to the wheels so that the wheels are driven.

The drive motor receives a maximum current to generate a maximum torque when the start button 36 is turned on.

The drive motor may also operate as a generator under energy regenerative conditions by braking, deceleration, downhill road traveling, or low-speed traveling so that the first battery is charged.

The inverter may convert the power of the first battery into driving power of the drive motor.

The inverter outputs the driving power of the drive motor based on a target traveling speed by a user command when the driving power of the drive motor is output. Here, the driving power of the drive motor may vary depending on a switching signal for outputting a current corresponding to the target traveling speed and a switching signal for outputting a voltage corresponding to the target traveling speed.

The inverter may also transmit the power generated from the drive motor to the first battery upon the regenerative braking. In other words, the inverter may include a plurality of switch elements and may also perform a function of changing a direction and output of the current between the drive motor and the first battery.

The reducer decelerates a speed of the drive motor and transmits the rotational force increasing a torque of the drive motor to the wheels.

The vehicle may further include the charging controller to which a quick charging cable or a slow charging cable is connected and configured to receive power for charging the first battery.

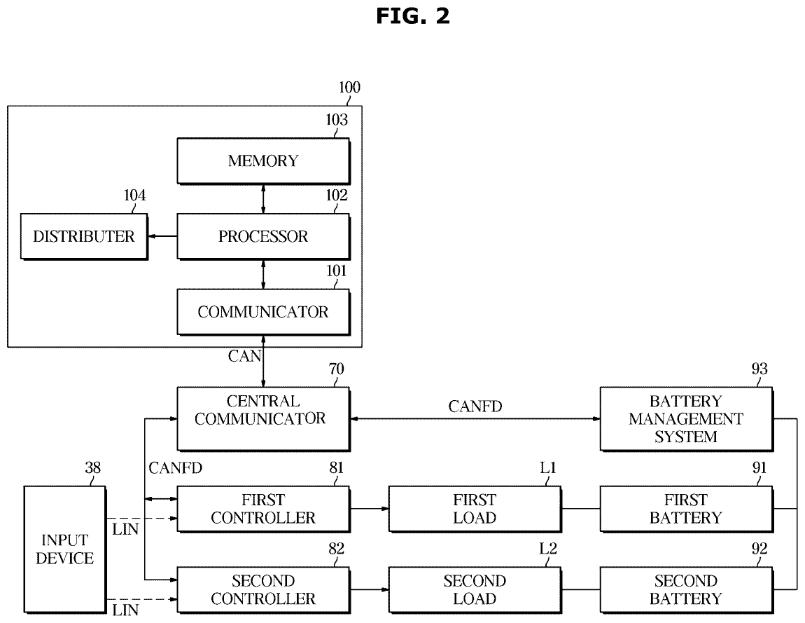

FIG. 2 is a control configuration diagram of the vehicle according to the embodiment.

The vehicle 1 includes the input device 38, a central communicator 70, a first controller 81, a second controller 82, a first battery 91, a second battery 92, a battery management system 93, and the power control device 100.

The input device 38 receives a user input.

The input device 38 may receive a start ON command, start OFF command, and shift command of the vehicle and receive at least one operation command and operation information of the electronic components provided in the vehicle.

For example, the operation command of at least one of the electronic components may include a cooling command, a heating command, radio ON/OFF commands, audio ON/OFF commands, navigation ON/OFF commands, a communication connection command with a user terminal, ON/OFF commands of the seat heating wire, ON/OFF commands of the seat ventilation device, ON/OFF commands of the heating wheel of the steering wheel, and the like.

The operation information of at least one of the electronic components may include indoor target temperature information, wind volume information, wind direction information, volume information, broadcasting channel information, target temperature information of the seat heating wire, wind volume information of the seat ventilation device, destination information, and the like.

The input device 38 may be provided in a vehicle terminal 40 and provided on the head unit or the center fascia of the vehicle 1.

The vehicle may further include the display device 39. The display device 39 may display the operation information and the like of the electronic component operating in the vehicle and display the user input input to the input device 38.

The display device 39 may be provided on the vehicle terminal 40 and provided on the head unit or the center fascia of the vehicle 1.

The central communicator (CCU) 70 may include one or more components configured to enable communication between external devices (not shown) and the components inside the vehicle and include, for example, at least one of a short-range communication module, a wired communication module, and a wireless communication module.

Here, the external device may include a server configured to provide a vehicle manufacturer, a vehicle maintenance center, or a vehicle maintenance app, a remote controller, and a user terminal.

The short-range communication module may include various short-range communication modules configured to transmit and receive signals using a wireless communication network in a short range, such as a Bluetooth module, an infrared communication module, a radio frequency identification (RFID) communication module, a wireless local access network (WLAN) communication module, a near field communication (NFC) module, a Zigbee communication module, and the like.

The wired communication module may include not only various wired communication modules, such as a CAN communication module, a local area network (LAN) module, a wide area network (WLAN) module, and a value added network (VAN) module, but also various cable communication modules, such as a universal serial bus (USB), a high definition multimedia interface (HDMI), a digital visual interface (DVI), a recommended standard232 (RS-232), power line communication, and a plain old telephone service (POTS).

The wired communication module may further include a local interconnect network (LIN).

In addition to a Wi-FI module and a wireless broadband module, the wireless communication modules may include a wireless communication module configured to support various wireless communication methods, such as global system for mobile communication (GSM), code division multiple access (CDMA), wideband code division multiple access (WCDMA), universal mobile telecommunications system (UMTS), time division multiple access (TDMA), long term evolution (LTE), ultra-wide band (UWB) modules.

The first controller 81 may be an electronic control unit (ECU) configured to control an operation of a first load L1. The first controller 81 according to an exemplary embodiment of the present disclosure may be a hardware device implemented by various electronic circuits (e.g., computer, microprocessor, CPU, ASIC, circuitry, logic circuits, etc.). The first controller 81 may be implemented by a non-transitory memory storing, e.g., a program(s), software instructions reproducing algorithms, etc., which, when executed, performs various functions described hereinafter, and a processor configured to execute the program(s), software instructions reproducing algorithms, etc. Herein, the memory and the processor may be implemented as separate semiconductor circuits. Alternatively, the memory and the processor may be implemented as a single integrated semiconductor circuit. The processor may embody one or more processor(s).

For example, the first controller 81 may be an air-conditioning controller configured to control a compressor and a heater of the HVAC 60.

The first controller 81 may recognize the first load based on the operation command and operation information received through the input device 38 and control the recognized first load based on the operation information of the load.

When the first load is a compressor, the first controller 81 may control the compressor of the HVAC 60, when receiving a cooling mode and indoor target temperature information and control the compressor, until an indoor temperature reaches a target temperature.

When the first load is the compressor, the first controller 81 may acquire a difference value between a detected current indoor temperature and the target temperature, and also control an operation rate of the compressor based on the acquired difference value and received wind volume information.

Here, the operation rate of the compressor may be a target amount of output of the compressor.

The target amount of output may be represented by a rate (%).

When the first load is the compressor, the first controller 81 may also control an amount of power supplied to the compressor based on the operation rate of the compressor.

Controlling the amount of power supplied to the compressor may include controlling a voltage or current applied to the compressor.

When the first load is an air-conditioning heater, the first controller 81 may control the air-conditioning heater when receiving a heating mode and indoor target temperature information and control the air-conditioning heater until the indoor temperature reaches a target temperature.

When the first load is an air-conditioning heater, the first controller 81 may acquire a difference value between the detected current indoor temperature and the target temperature, and also control an operation rate of the air-conditioning heater based on the acquired difference value and the received wind volume information.

When the first load is the air-conditioning heater, the first controller 81 may also control an amount of power supplied to the air-conditioning heater based on the operation rate of the air-conditioning heater.

Here, the operation rate of the air-conditioning heater may be an output of the air-conditioning heater.

Controlling the amount of power supplied to the air-conditioning heater may include controlling a voltage or current applied to the air-conditioning heater.

The first controller 81 may control the output of the first load L1 in response to the control command and output control information of the power control device 100. Here, the output control information may include information on an increase in the output, a decrease in the output, an increase control section of the output, and a decrease control section of the output and further include information on various times when the output is controlled.

To control the output of the first load L1, the first controller 81 may control an amount of power supplied to the first load L1.

The first controller 81 may control the power of the first load L1 in response to the power control information of the power control device 100. Here, the power control information may include information on the increase in the power, the decrease in the power, an increase control section of the power, and a decrease control section of the power and further include information on various times when the power is controlled.

The second controller 82 may be the ECU configured to control an operation of the second load L2.

For example, the second controller 82 may include a body controller configured to control a door lock device, a wiper, a power seat, a seat heating wire, a seat ventilation device, an indoor lamp, and a power tailgate, communication controller configured to control a communication device, and a terminal controller configured to control the vehicle terminal 40 to perform at least one of an audio mode, a video mode, a navigation mode, a broadcasting mode (DMB function), and a radio mode.

The first controller 81 and the second controller 82 may perform collaborative control with the power control device 100.

The first battery 91 may be charged and discharged. The first battery 91 may be charged by receiving external power and charged using power generated upon regenerative braking.

The first battery 91 supplies power to a power train including a drive motor and the like and the first load L1 consuming high power.

The first load L1 may include the compressor or the heater of the HVAC.

The first load L1 may be a load configured to receive a voltage higher than or equal to a preset voltage.

The first battery 91 may also supply power to the second battery 92.

The second battery 92 may be charged and discharged.

The second battery 92 may be charged using the power charged in the first battery 91.

The second battery 92 supplies power to electronic components, such as convenience devices and additional devices. The second battery 92 may supply the power to the second load L2 regardless of the start ON/OFF.

The second load L2 may be a load configured to receive a voltage lower than the preset voltage.

The second load L2 may be a load configured to consume the operation by receiving a lower voltage than the voltage consumed in the first load L1. For example, the second load L2 may include a vehicle terminal, a lamp, a heating wire, and the like.

The vehicle may further include a converter (not shown). The converter converts direct current (DC) power of the first battery 91 into DC power suitable for charging the second battery 92 and supplies the converted DC power to the second battery 92 so that the second battery 92 may be charged.

The converter may include at least one switch element and inductor.

The battery management system (BMS) 93 may acquire state information of the first and second batteries 91 and 92.

The battery management system 93 may include a plurality of sensors (not shown) configured to collect information on states of the first and second batteries 91 and 92, such as output voltages of the first and second batteries 91 and 92, input/output currents of the first and second batteries 91 and 92, and temperatures of the first and second batteries 91 and 92.

The plurality of sensors may include a plurality of current sensors configured to detect currents of the first and second batteries 91 and 92, respectively, a plurality of voltage sensors configured to detect voltages at output terminals of the first and second batteries 91 and 92, respectively, and a plurality of temperature sensors configured to detect temperatures of the first and second batteries 91 and 92, respectively.

In addition, the battery management system 93 may include a management controller (not shown) configured to calculate and manage a state of charge (SoC) of each of the first and second batteries 91 and 92, a state of health (SoH) of each of the first and second batteries 91 and 92, and the like based on information on the states of the first and second batteries 91 and 92.

The battery management system 93 may monitor the SoCs of the first and second batteries 91 and 92 and transmit the state information on the SoCs of the first and second batteries 91 and 92 to the power control device 100.

The battery management system 93 may acquire the SoC of the battery corresponding to a current, voltage, and temperature of each battery cell from a pre-stored table. In the pre-stored table, charged amounts of the first and second batteries corresponding to the correlation between the currents, voltages, and temperatures of the first and second batteries, respectively may be matched.

The battery management system 93 of the embodiment may monitor the first battery 91. The battery management system 93 may monitor information on the voltage, current, and power of the first battery 91 and transmit the monitoring information to the power control device 100.

The battery management system 93 may transmit information on the charged amount of the first battery 91 to the power control device 100. The charged amount of the first battery 91 may be the SoC of the first battery.

The power control device 100 may be a device configured to manage power for high voltage.

The power control device 100 may also manage power for low voltage.

The power control device (PDC: powernet domain controller) 100 monitors a power state of the entire vehicle.

The power state of the entire vehicle may be a state using the power charged to the first battery 91.

The power control device 100 determines whether an auto power output is required based on the monitored total amount of power.

The auto power output is to minimize the power consumption of the first battery 91 according to a user input or an internal control logic. The auto power output may be selectively operated according to the user's needs. For example, it is possible to minimize the consumption of the first battery 91 by the user's selecting an auto power output mode through the input device 38.

In addition, the power control device 100 may also automatically determine the auto power output to minimize the power consumption when peak power is generated.

When it is determined that the auto power output is required, the power control device 100 may perform voltage output control by the auto power. On the contrary, the power control device 100 may maintain the existing power control when there is no selection command for the auto power output or the auto power output is unnecessary.

The power control device 100 may decrease the power consumed in the first load L1 by decreasing the voltage applied to the first load L1 which is a high-voltage load requiring a relatively high voltage.

The power control device 100 for the auto power output will be described in more detail.

The power control device 100 may determine that the peak power has been generated when the monitored total amount of power is greater than or equal to a preset amount of peak power when performing the control for the auto power output.

When it is determined that the peak power has been generated, the power control device 100 may control the power consumed in the first load L1, thereby decreasing the amount of power consumed in the entire vehicle.

In order to control the power consumed in the first load L1, the power control device 100 may acquire the output control information of the first load based on the amount of power for decrease and transmit the acquired output control information to the first controller 81. In this case, the first controller 81 may control the output of the first load L1 based on the received output control information.

The power control device 100 may also transmit the power control information to the first load L1. Here, the power control information may include the decrease in the power consumed in the first load L1. In this case, the first controller 81 may acquire the output control information based on the received power control information and control the output of the first load L1 based on the acquired output control information. Here, the output control information may include the decrease in the output of the first load L1.

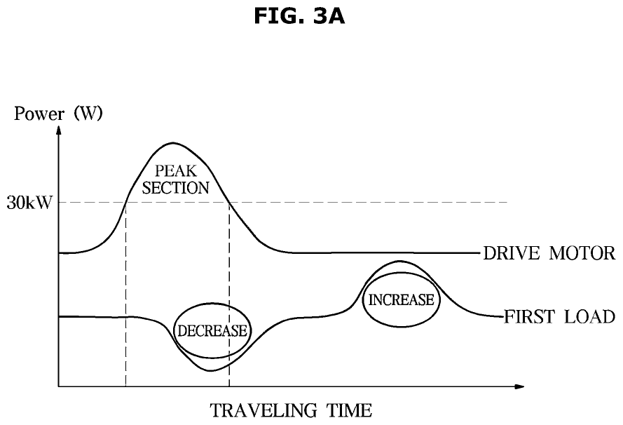

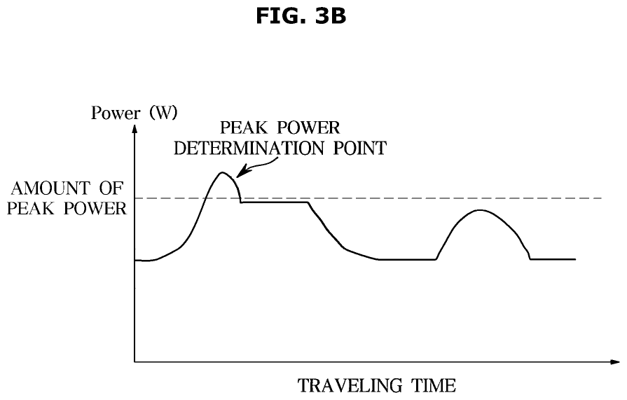

After the output of the first load L1 is decreased, the power control device 100 may distribute the amount of power consumed in the entire vehicle 1 while maintaining the total output of the first load L1 by returning the output of the first load L1 or increasing the output of the first load L1. This will be described with reference to FIGS. 3A and 3B.

FIG. 3A is a graph showing an amount of power consumed by the drive motor over a traveling time and the amount of power consumed by the first load L1, and FIG. 3B is a graph showing the amount of power of the entire vehicle over the traveling time. The traveling time is a time the vehicle has moved since the vehicle was started.

As shown in FIG. 3B, the power control device 100 determines that the peak power has been generated when the total power is greater than or equal to a preset amount of peak power, confirms the total power consumed in a peak section in which the peak power is generated, and acquires a difference value between the confirmed total power in the peak section and the preset amount of peak power.

As shown in FIG. 3A, the power control device 100 may control the first load so that the amount of power consumed in the first load L1 is decreased based on the acquired difference value. At this time, the amount of output of the first load L1 may be decreased by the decrease in the amount of power.

As shown in FIG. 3B, the power control device 100 confirms the total amount of power consumed in the entire vehicle after the peak section is released and compares the confirmed total amount of power and the acquired difference value.

As shown in FIG. 3B, when it is determined that the total amount of power has been smaller than the acquired difference value, the power control device 100 may return the amount of power consumed in the first load L1 or increase the amount of power consumed in the first load L1.

In other words, the power control device 100 may return the amount of output to the amount of output before the amount of output of the first load L1 is decreased or increase the amount of output to the amount of output greater than or equal to the amount of output before the amount of output of the first load L1 is decreased. At this time, the amount of output of the first load L1 may be returned by returning the amount of power and increased by increasing the amount of power.

The power control device 100 may distribute the amount of power consumed in the entire vehicle 1.

The power control device 100 may include a communicator 101, a processor 102 (e.g., computer, microprocessor, CPU, ASIC, circuitry, logic circuits, etc.), and a memory 103 and further include a distributer 104. The memory 103 may store software instructions which, when executed by the processor 102, provides the functionality of the communicator 101, and the distributer 104. Herein, the processor 102 and the memory 103 may be implemented as separate semiconductor circuits. Alternatively, the processor 102 and the memory 103 may be implemented as a single integrated semiconductor circuit. The processor may embody one or more processor(s).

The communicator 101 may communicate with the central communicator 70.

The communicator 101 may transmit and receive information with a plurality of controllers through the communication with the central communicator 70 and transmit and receive information with the battery management system 93 through the communication with the central communicator 70.

The communicator 101 may perform communication of a local interconnect network (LIN) method, a controller area network (CAN) method, or a pulse width modulation (PWM) method.

The processor 102 may receive information on the amount of power consumed in the entire vehicle from the battery management system 93.

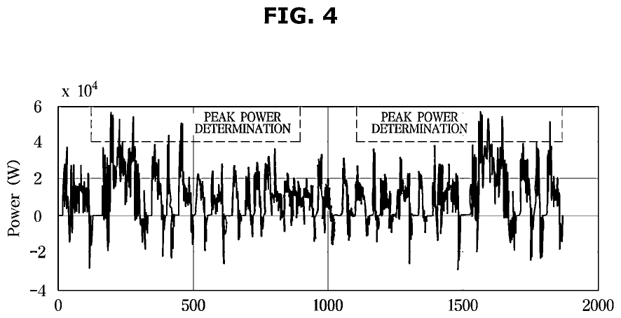

As shown in FIG. 4, the processor 102 may monitor the amount of power consumed in the entire vehicle and determine that the peak power has been generated when the monitored total amount of power is greater than or equal to the preset amount of peak power.

The processor 102 may determine the section in which the peak power is generated as the peak section and control the amount of power consumed in the first load L1 in the peak section to be decreased.

The processor 102 may control the power consumed in the first load L1 to be returned or increased when the peak section is released.

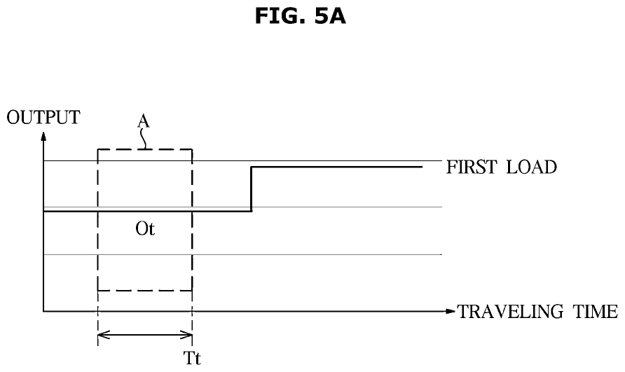

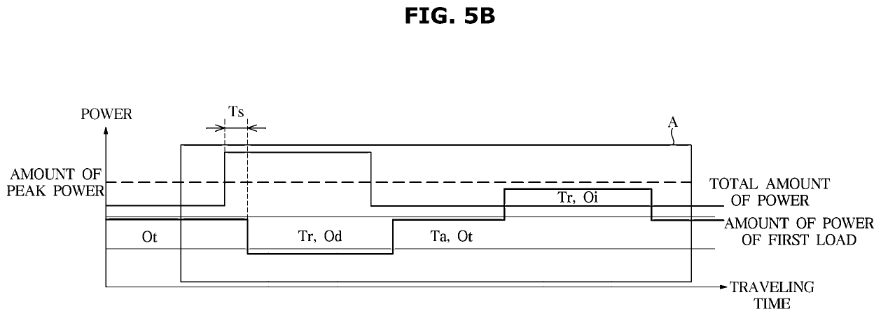

This will be described in more detail with reference to FIGS. 5A and 5B.

FIG. 5A is a graph for a target amount of output of the first load L1 over traveling time, and FIG. 5B is a graph for the total amount of power of the vehicle and the amount of power of the first load L1 over the traveling time.

As shown in FIG. 5A, the processor 102 may acquire the target amount of output of the first load over the traveling time based on the operation information of the first load L1 received through the input device 38. In other words, the processor 102 may acquire the target amount of output of the first load for each traveling time.

For example, when the first load is the compressor, the processor 102 may acquire a difference value between a current indoor temperature detected by an indoor temperature sensor (not shown) and a target indoor temperature and also acquire a target amount of output of the compressor over the traveling time based on the acquired temperature difference value.

When the first load is the air-conditioning heater, the processor 102 may acquire the difference value between the current indoor temperature detected by the indoor temperature sensor (not shown) and the target room temperature and also acquire the target amount of output of the air-conditioning heater over the traveling time based on the acquired difference value.

The processor 102 may also receive the target amount of output of the first load L1 over the traveling time from the first controller 81.

The processor 102 may acquire the amount of power consumed in the first load L1 corresponding to the target amount of output of the first load L1 over the traveling time and control the first battery 91 and the first controller 81 to supply power to the first load L1 based on the amount of power of the first load L1 over the traveling time.

As shown in FIG. 5B, the processor 102 may monitor the amount of power consumed in the entire vehicle, confirm a time when the total amount of power is maintained as the preset amount of peak power or more when it is determined that the monitored total amount of power is greater than or equal to the preset amount of peak power, and determine the corresponding time as the peak section when it is determined that the confirmed time is longer than or equal to a preset time Ts.

In other words, the processor 102 may determine a certain time after a time point at which the total amount of power reaches the preset amount of peak power or more as the peak section.

The processor 102 may acquire a power control time when the entire power or the power of the first load is controlled based on the certain time when the peak section is formed.

The certain time may be information acquired by the experiment and stored.

The certain time may be the information predicted by a traveling speed and the operation information of the first load.

The preset amount of peak power is the amount of power for determining peak generation in the vehicle and may vary depending on the traveling speed of the vehicle.

Since the torque of the drive motor varies depending on the traveling speed of the vehicle and the default amount of power consumed in the drive motor also increase as the torque of the drive motor increases, the peak power also varies depending on the traveling speed of the vehicle.

The processor 102 may acquire the traveling speed of the vehicle based on speed information detected by a speed sensor (not shown), acquire the amount of peak power corresponding to the acquired traveling speed, and set the acquired amount of peak power as information for determining the generation of the peak power.

The processor 102 may confirm the target amount of output of the first load L1 at a first time point at which the total amount of power reaches the preset amount of peak power or more, confirm a second time point at which the confirmed target amount of output is changed based on the target amount of output of the first load for each traveling time, and determine a time between the confirmed first time point and second time point as the peak section.

Here, the time between the first time point and the second time point may be the certain time.

The processor 102 may confirm the traveling speed at the time point at which the total amount of power reaches the preset amount of peak power or more, confirm the default amount of power of the drive motor for each traveling time corresponding to the confirmed traveling speed, confirm the target amount of power of the first load for each traveling time based on the target amount of output of the first load for each traveling time, predict the total amount of power for each traveling time based on the confirmed default amount of power of the drive motor and target amount of power of the first load for each traveling time, and also predict a peak section Tt in which the peak power is generated and the certain time when the peak section is formed based on the predicted total amount of power for each traveling time and the preset amount of peak power.

Here, information on the default amount of power consumed in the drive motor corresponding to the traveling speed and information on the target amount of power of the first load corresponding to the target amount of output of the first load may be information acquired by the experiment and stored in advance.

As shown in FIG. 5B, the processor 102 may control the power consumed in the first load L1 at a time point at which the preset time Ts elapses from the time point at which the peak power is generated. In this case, the first controller 81 may decrease the output of the first load L1.

The processor 102 may control the first load L1 so that the output of the first load L1 is decreased by a preset decrease Od for a first reference time Tr from the time point at which the preset time Ts elapses.

The processor 102 may subtract the preset decrease Od from the target amount of output Ot of the first load L1 at the time point at which the peak power is generated, acquire the amount of power corresponding to the subtracted amount of output, and control the power supplied to the first load L1 based on the acquired amount of power.

The processor 102 may change the amount of output of the first load L1 to the target amount of output for a second reference time Ta when the first reference time Tr elapses from the time point at which the output of the first load L1 is decreased and control the power supplied to the first load L1 to supply the amount of power corresponding to the changed target amount of output.

The processor 102 may control the output of the first load L1 to be increased by a preset increase Oi for the first reference time Tr when the second reference time Ta elapses from the time point at which the output of the first load L1 is changed to the target amount of output.

The processor 102 may sum the target amount of output Ot of the first load and the preset increase Oi at the time point at which the peak power is generated, acquire the amount of power corresponding to the summed amount of output, and control the power supplied to the first load L1 based on the acquired amount of power.

The processor 102 changes the amount of output of the first load L1 to the target amount of output when the first reference time Tr elapses from the time point at which the amount of output increases and controls the power supplied to the first load L1 to supply the amount of power corresponding to the changed target amount of output Ot.

The preset decrease Od is the amount corresponding to a certain rate of the target amount of output of the first load L1 and the amount of a negative certain rate. The preset decrease Od may be the decrease corresponding to a difference value between the total amount of power and the preset amount of peak power.

The preset increase Oi is the amount corresponding to the preset amount in decrease Od, the amount corresponding to the certain rate of the target amount of output of the first load L1, and the amount of a positive constant rate.

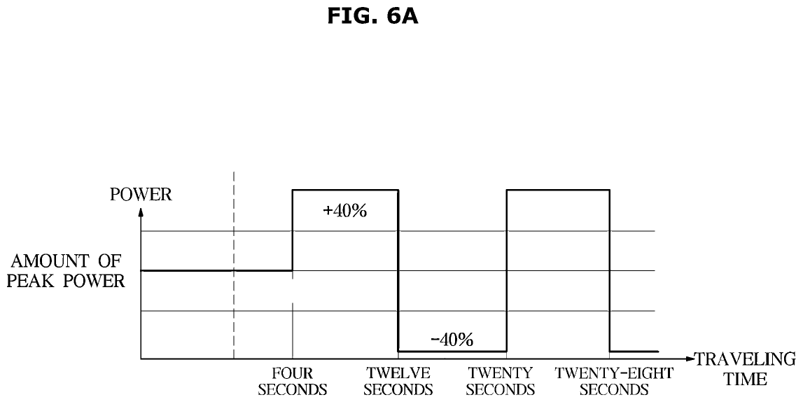

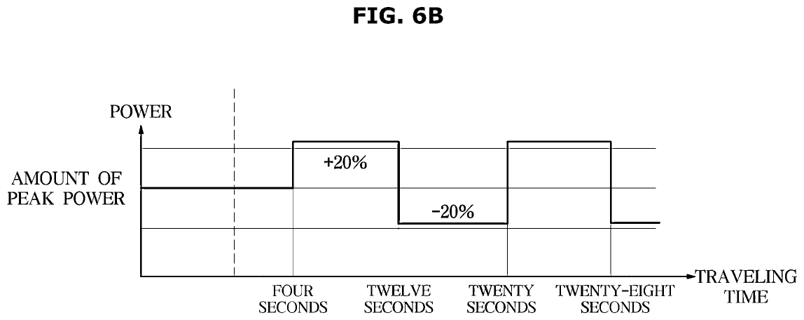

The preset decrease may be the amount of output corresponding to the difference value between the total amount of power and the preset amount of peak power. This will be described with reference to FIGS. 6A and 6B.

As shown in FIG. 6A, the processor 102 may confirm the difference value between the total amount of power and the preset amount of peak power and acquire the preset decrease as −40% of the preset amount of peak power and acquire the preset increase as +40% of the preset amount of peak power when it is determined that the confirmed difference value corresponds to 40% of the preset amount of peak power.

As shown in FIG. 6B, the processor 102 may confirm the difference value between the total amount of power and the preset amount of peak power and acquire the preset decrease as −20% of the preset amount of peak power and acquire the preset increase as +20% of the preset amount of peak power when it is determined that the confirmed difference value corresponds to 20% of the preset amount of peak power.

The first reference time Tr may be a time acquired based on the peak section.

The first reference time Tr is acquired by the experiment and may also be a time preset and stored.

The second reference time Ta is acquired by the experiment and may also be a time preset and stored.

The second reference time Ta may also be a time set corresponding to the traveling speed of the vehicle.

The second reference time Ta may be acquired by subtracting the first reference time Tr twice and the preset time Ts from the total power control time Tt when the amount of output of the first load needs to be controlled by the generation of the peak power.

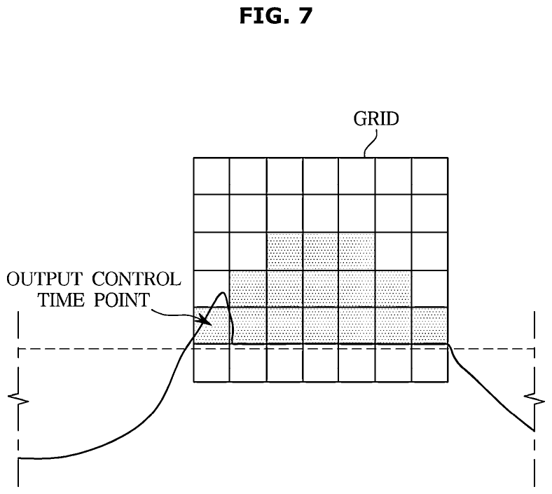

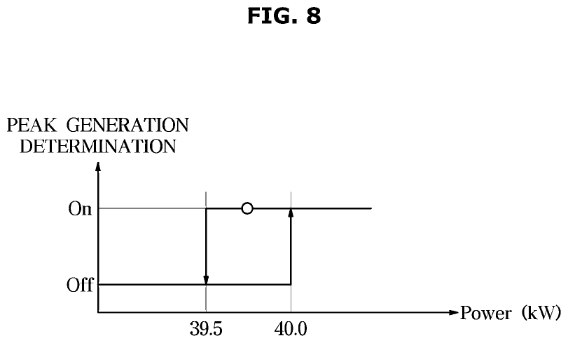

When it is determined that the peak power has been generated, the processor 102 may acquire the output control time point at which the output of the first load L1 is controlled based on the peak power. This will be described with reference to FIGS. 7 and 8.

The processor 102 confirms the traveling speed for each traveling time and the target amount of output of the first load L1, predicts the total amount of power for each traveling time based on the confirmed traveling speed for each traveling time and the target amount of output of the first load L1, confirms the preset amount of peak power corresponding to the traveling speed, and confirms whether the total amount of power is greater than or equal to the preset amount of peak power based on the predicted total amount of power for each traveling time and the preset amount of peak power.

As shown in FIG. 7, the processor 102 may acquire a graph of the peak power in which the total power of power is greater than or equal to the preset amount of peak power, form a grid having a certain size in the acquired graph, and acquire areas of cells by the grid, and may acquire an area of a region formed by the graph of the peak power, confirm cells in which the acquire area is greater than or equal to a set rate, confirm a cell formed at the earliest time point from the traveling time point among the confirmed cells, and acquire a time point of the confirmed cell as the output control time point of the first load L1.

As shown in FIG. 8, the processor 102 may determine that the peak power has been generated when the total amount of power is greater than or equal to a preset first amount of power and determine that the peak power is not generated when the total amount of power is smaller than a preset second amount of power.

When the total amount of power is smaller than the preset first amount of power and greater than or equal to the second amount of power, the processor 102 may determine this as hysteresis.

When it is determined that the peak power has been generated, the processor 102 may transmit output decrease control information of the load to the first controller and transmit output increase control information of the load to the first controller when it is determined that the generation of the peak power has been released.

The processor 102 may acquire the decrease and the increase in the output of the load based on the difference between the total amount of power and the amount of peak power and transmit the acquired increase and the decrease of the output to the first controller.

The processor 102 may acquire the target amount of output for each traveling time based on the operation information of the load received in the input device, acquire the target amount of power for each traveling time corresponding to the acquired target amount of output for each traveling time, acquire the default amount of power for each traveling time based on the traveling speed detected by the speed sensor, acquire the reference time when the output of the load is controlled based on the acquired target amount of power for each traveling time and the acquired default amount of power for each traveling time, and transmit the acquired reference time to the first controller.

The processor 102 may predict the total amount of power for each traveling time based on the acquired target amount of power for each traveling time and the acquired default amount of power for each traveling time, confirm a time period in which the predicted total amount of power for each traveling time is smaller than the reference amount of power, acquire the confirmed time period as the increase control section, and transmit information on the increase control section to the first controller.

The processor 102 may confirm the number of time periods in which the predicted total amount of power for each traveling time is smaller than the reference amount of power and transmit information on the confirmed number and the acquired increase in the output to the first controller.

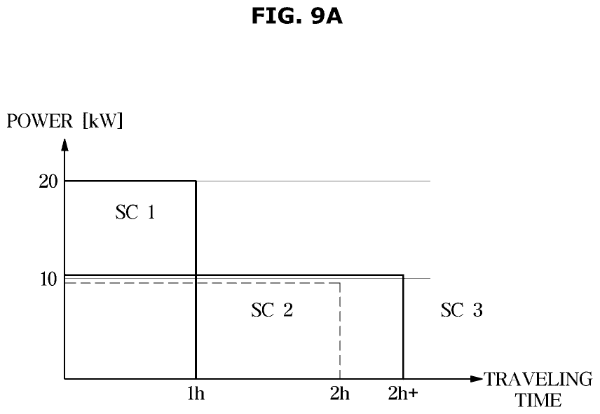

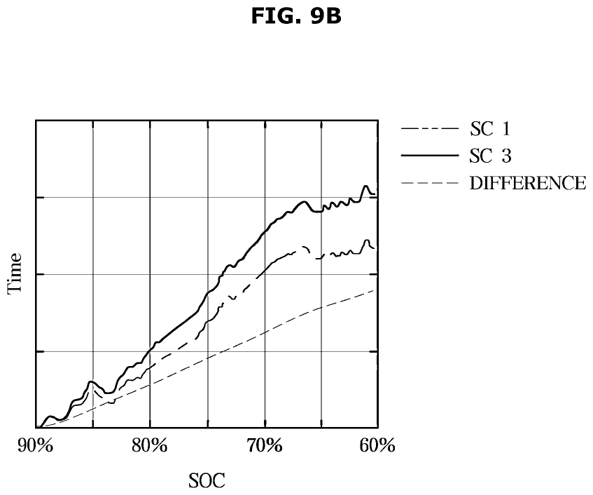

FIG. 9A is a graph of the amount of power consumed per unit time consumed in the vehicle according to the embodiment. Here, the unit time may be one hour.

FIG. 9A is a graph showing when the amount of power of 20 kW is consumed for one hour (SC1) and when the amount of power of 10 kW is consumed for two hours (SC2 and SC3).

As shown in FIG. 9A, when the amount of power which may be consumed per unit time is decreased from 20 kW to 10 kW, power of 20 kW may be arithmetically consumed for two hours. However, substantially, when the amount of power which may be consumed per unit time is decreased from 20 kW to 10 kW, the power of 20 kW may be consumed for a little longer than two hours.

FIG. 9B is a graph of the charged amount of a battery responding to a change in the amount of power to be consumed per unit time consumed in the vehicle according to the embodiment.

As shown in FIG. 9B, it can be seen that the time when the SoC of the first battery 91 is decreased increases when the amount of power which may be consumed per unit time is 10 kW rather than when the amount of power which may be consumed per unit time is 20 kW.

In other words, it can be seen that the longer the time taken to consume the power of 20 kW, the longer the vehicle may travel, even when the same power of 20 kW is consumed.

The memory 103 may store information on the target amount of output and the target amount of output corresponding to the operation information of the first load L1.

The memory 103 may store information on the target amount of output and the target amount of power corresponding to the operation information of the first load L1 and current environment information.

Here, the current environment information is the indoor temperature of the vehicle and may include temperature information detected by the indoor temperature sensor (not shown).

The memory 103 may store the decrease in the output of the first load L1 corresponding to the difference value between the total amount of power and the preset amount of peak power.

When a plurality of first loads are provided, the memory 103 may store the decrease in output corresponding to the difference value between the total amount of power and the preset amount of peak power by load.

The memory 103 may store information on the amount of peak power corresponding to the traveling speed and the default amount of power of the drive motor.

The amount of peak power corresponding to the traveling speed may be information acquired by the test at the time of manufacturing the vehicle.

The memory 103 may store the amount of peak power corresponding to a gradient of a road, the traveling speed, and a driver's traveling pattern. In this case, the amount of peak power may be information acquired and learned based on the gradient of the road, the traveling speed, and the driver's traveling pattern.

The traveling pattern may include a pressing pattern of an accelerator pedal and a pressing pattern of a brake pedal corresponding to the gradient of the road and the traveling speed.

The memory 103 may periodically update the amount of peak power corresponding to the gradient of the road, the traveling speed, and the driver's traveling pattern.

The memory 103 may store information on the preset time, the first reference time, and the second reference time when the output and power of the first load are controlled and also store information on the preset decrease and the preset increase.

The memory 103 may be implemented as at least one of non-volatile memory devices, such as a cache, a read only memory (ROM), a programmable ROM (PROM), an erasable programmable ROM (EPROM), an electrically erasable programmable ROM (EEPROM), and a flash memory, volatile memory devices, such as a random access memory (RAM), and storage media, such as a hard disk drive (HDD) and a CD-ROM, but the present disclosure is not limited thereto.

The memory 103 may be a memory implemented as a separate chip from the processor described above in connection with the processor 102 and may also be implemented as a single chip with the processor.

The distributer 104 includes a plurality of switches.

The plurality of switches may be turned on or off in response to a control command of the processor 102. Each switch may be a relay.

The plurality of switches may include first and second switches configured to supply the power of the first battery 91 and include a third switch configured to supply the power of the second battery 92.

The first switch is connected between the first battery 91 and the drive motor and is configured to supply the power of the first battery 91 to the drive motor in response to an ON operation and cut off the power of the first battery 91 supplied to the drive motor in response to an OFF operation.

The second switch is connected between the first battery 91 and the first load L1 and is configured to supply the power of the first battery 91 to the first load L1 consuming high power in response to an ON operation and cut off the power of the first battery 91 supplied to the first load L1 in response to an OFF operation.

The third switch is connected between the second battery 92 and the second load L2 and configured to supply the power of the second battery 92 to the second load L2 consuming low power in response to an ON operation and cut off the power of the second battery 92 supplied to the second load L2 in response to an OFF operation.

The power control device 100 may be implemented by the memory 103 configured to store data on an algorithm for controlling the operations of the components in the power control device or a program for reproducing the algorithm and the processor 102 configured to perform the above-described operation using the data stored in the memory 103.

In this case, the memory 103 and the processor 102 may be implemented as separate chips, respectively. Alternatively, the memory 103 and the processor 102 may also be implemented as a single chip.

At least one component may be added or deleted depending on the performance of the components of the power control device shown in FIG. 2. In addition, it will be readily understood by those skilled in the art that mutual positions of the components may be changed depending on the performance or structure of the power control device.

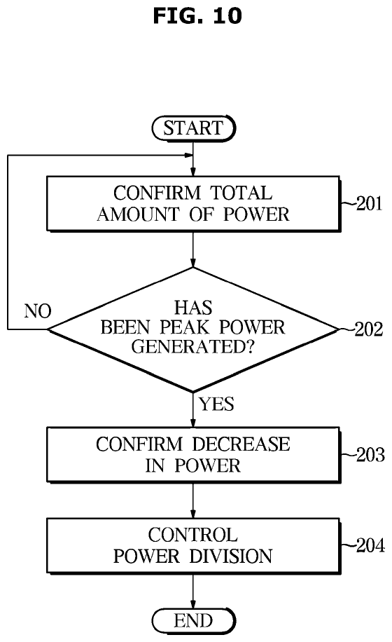

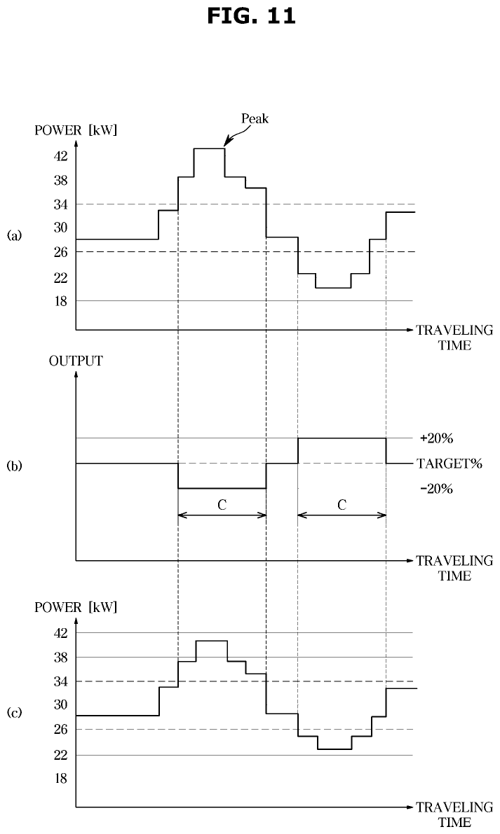

FIG. 10 is a control flowchart of a power control device provided in the vehicle according to the embodiment and will be described with reference to FIGS. 11A, 11B, 11C, 12A, 12b, 12C, 13A, 13B, and 13C.

FIGS. 11A, 11B, 11C, 12A, 12b, 12C, 13A, 13B, and 13C are graphs of the output control of the first load and changes in total amount of power through the power control device according to the embodiment.

The power control device 100 may receive the total amount of power consumed in the entire vehicle from the battery management system 93.

The power control device 100 confirms the total amount of power consumed in the entire vehicle (201).

The power control device 100 may acquire the traveling speed of the vehicle based on the speed information detected by the speed sensor (not shown), confirm the amount of peak power corresponding to the acquired traveling speed, and set the confirmed amount of peak power to information for determining the generation of the peak power.

The amount of peak power corresponding to the traveling speed may be the amount of power which is as high as the preset rate from the default amount of power consumed in the drive motor for each traveling speed.

Here, the preset rate may also be the same or may vary depending on the traveling speed.

The amount of peak power is due to the total power consumed in the first battery 91.

The power control device 100 compares the total amount of power with the preset amount of peak power to determine whether the peak power has been generated (202).

The power control device 100 may acquire the target amount of output of the first load over the traveling time based on the operation information of the first load L1 received through the input device 38 and acquire the target amount of output for each traveling time corresponding to the target amount of output.

For example, when the first load is the compressor, the power control device 100 may acquire the difference value between the current indoor temperature detected by the indoor temperature sensor (not shown) and the target indoor temperature, acquire the target amount of output of the compressor over the traveling time based on the acquired temperature difference value, and also acquire the target amount of power corresponding to the acquired target amount of output of the compressor.

When the first load is the air-conditioning heater, the power control device 100 may acquire the difference value between the current indoor temperature detected by the indoor temperature sensor (not shown) and the target indoor temperature, acquire the target amount of output of the air-conditioning heater over the traveling time based on the acquired temperature difference value, and also acquire the target amount of power corresponding to the acquired target amount of output of the air-conditioning heater.

The power control device 100 may receive the target amount of output of the first load L1 for each traveling time from the first controller 81 and also acquire the target amount of power corresponding to the received target amount of output.

The power control device 100 may also receive the target amount of power of the first load L1 for each traveling time from the first controller 81.

The power control device 100 may predict the total amount of power for each traveling time based on the amount of power of the drive motor for each traveling time and the target amount of power of the first load for each traveling time and also determine whether the peak power has been generated based on the predicted total amount of power for each traveling time and the preset amount of peak power.

The power control device 100 determines that peak power has been generated when it is determined that the total amount of power is greater than or equal to the preset amount of peak power and determines that the peak power has not been generated when it is determined that the total amount of power is smaller than the preset amount of peak power.

The power control device 100 may confirm the time when the total amount of power is maintained to the preset amount of power or more when it is determined that the total amount of power is greater than or equal to the preset amount of peak power, determine that the peak power has been generated when it is determined that the confirmed time is longer than or equal to the preset time Ts, and also determine that the peak power has not been generated when it is determined that the confirmed time is smaller than the preset time Ts (see FIG. 5B).

The power control device 100 may confirm the time point at which the preset time Ts elapses from the time point at which the peak power is generated and acquire the confirmed time point as the output control time point of the first load L1.

The power control device 100 may acquire the graph of the peak power in which the total amount of power is greater than or equal to the preset amount of peak power, form the grid having the certain size in the acquired graph, and acquire the areas of the cells by the grid and may acquire the area of the region formed by the graph of the peak power, confirm the cells in which the acquired area is greater than or equal to the set rate, confirm the cell formed at the earliest time point from the traveling time point among the confirmed cells, and acquire the time point of the confirmed cell as the output control time point of the first load L1 (see FIG. 7).

The power control device 100 acquires the power difference value between the total amount of power and the preset amount of peak power and confirms the decrease in the power corresponding to the acquired power difference value (203).

When predicting the total amount of power based on the traveling speed and the target amount of output of the first load, the power control device 100 may acquire the information on the peak section in which the peak power is generated.

When it is determined that the peak power has been generated based on the total amount of power transmitted from the battery management system, the power control device 100 may acquire the information on the peak section based on the preset time.

The power control device 100 may acquire the certain time when the peak section is formed.

For example, the power control device 100 may confirm the target amount of output of the first load L1 at the first time point at which the total amount of power reaches the preset amount of peak power or more, confirm the second time point at which the confirmed target amount of output is changed based on the target amount of output of the first load for each traveling time, determine the time between the confirmed first time point and second time point as the peak section, and acquire the time between the first time point and the second time point as the certain time.

For another example, the power control device 100 may confirm the traveling speed at the time point at which the total amount of power reaches the preset amount of peak power or more, confirm the default amount of power of the drive motor for each traveling time corresponding to the confirmed traveling speed, confirm the target amount of power of the first load for each traveling time based on the target amount of output of the first load L1 for each traveling time, predict the total amount of power for each traveling time based on the confirmed default amount of power of the drive motor for each traveling time and target amount of power of the first load L1 for each traveling time, and also predict the peak section Tt in which the peak power is generated and the certain time when the peak section is formed based on the predicted total amount of power for each traveling time and the preset amount of peak power.

The power control device 100 may control the division of the power of the entire vehicle (204) by confirming the power control time based on the certain time when the peak power is formed and controlling the output and power of the first load L1 based on the confirmed power control time and the decrease in the power.

The power control device 100 may control the power of the first load L1 by acquiring a decrease control section of the output of the first load L1 and the increase control section of the output of the first load L1 based on the total amount of power over the predicted traveling time, controlling the decrease in the output of the first load L1 in the acquired decrease control section of the output of the first load L1, and controlling the increase in the output of the first load L1 in the increase control section of the output of the first load L1.

The power control device 100 may acquire the time period in which the total amount of power is smaller than the reference amount of power based on the total amount of power over the predicted traveling time as the increase control section, confirm the number of acquired increase control sections and the time when the acquired increase control section is formed, and dividedly control the increase in the output of the first load based on the confirmed number and time period.

For example, when the number of acquired increase control sections is one and the time of the increase control section is longer than or equal to the certain time, the power control device 100 may control the output of the first load L1 to be increased by the increase corresponding to the decrease in one increase control section.

When the number of acquired increase control sections is one and the time of the increase control section is shorter than the certain time, the power control device 100 may control the output of the first load L1 to be increased by the increase corresponding to the decrease in one increase control section and control the output of the first load L1 to be increased by the amount of double increase for half of the certain time.

When the number of acquired increase control sections is two and the time of the increase control section is shorter than the certain time, the power control device 100 may confirm the increase corresponding to the decrease and control the output of the first load L1 to be increased by the increase confirmed for the two increase control sections.

Therefore, the power control device 100 may perform power division control of the entire vehicle.

This will be described with reference to FIGS. 11A, 11B, 11C, 12A, 12B, 12C, 13A, 13B, and 13C.

The power control device 100 confirms the target amount of output before the output control time point of the first load L1 and confirms the target amount of power corresponding to the confirmed target amount of output.

The power control device 100 acquires the power difference value between the confirmed decrease in the power and the confirmed target amount of power and acquires the decrease in the output corresponding to the acquired power difference value.

The power control device 100 may control the first load based on the acquired decrease in the output. The power control device 100 may also transmit the decrease in the output of the first load to the first controller.

A case in which the output of the first load is controlled based on the acquired decrease in the output of the first load and the certain time when the peak section is formed will be described.

An example in which the output of the first load is controlled will be described.

FIG. 11A is a graph showing the total amount of power of the vehicle when the output of the first load is not controlled in response to the generation of the peak power.

FIG. 11B is a graph in which the output of the first load is controlled in response to the generation of the peak power.

FIG. 11C is a graph showing the total amount of power of the vehicle when the output of the first load is controlled in response to the generation of the peak power.

When it is determined that the peak power has been generated, the power control device 100 confirms the target amount of output of the first load at the time point at which the peak power is generated and acquires the decrease corresponding to the difference between the amount of peak power and the total amount of power.

The power control device 100 confirms the time period in which the total amount of power is smaller than the reference amount of power based on the total amount of power over the traveling time, acquires the confirmed time period as the increase control section, confirms the number of acquired increase control sections and the time of the increase control section, and determines whether the confirmed time is longer than or equal to the certain time.

As shown in FIG. 11A, the power control device 100 may confirm that the number of increase control sections is one and the time when the increase control section is formed is longer than or equal to the certain time.

As shown in FIG. 11B, the power control device 100 may subtract the preset decrease Od from the target amount of output of the first load L1 in the decrease control section and control the operation of the first load based on the subtracted amount of output.

The power control device 100 may acquire the amount of power corresponding to the subtracted amount of output and control the power supplied to the first load to be decreased based on the acquired amount of power.

The power control device 100 may confirm a certain time C when the peak section is formed and control the power supplied to the first load to be decreased for the confirmed certain time.

As shown in FIG. 11B, the power control device 100 may change the amount of output of the first load L1 to the target amount of output when the certain time elapses and control the operation of the first load L1 based on the changed target amount of output.

The power control device 100 may acquire the target amount of power corresponding to the target amount of output and control the power supplied to the first load L1 to be returned based on the acquired target amount of power.

The power control device 100 may control the power supplied to the first load L1 to be returned for the set time. Here, the set time may be a time shorter than the certain time and may vary depending on the certain time.

As shown in FIG. 11B, the power control device may acquire the amount of output of the first load L1 by summing the target amount of output and the preset increase Oi for the increase control section when the set time elapses and control the operation of the first load L1 based on the acquired amount of output.

The increase Oi may correspond to the decrease.

The power control device 100 may acquire the amount of power corresponding to the acquired amount of output and control the amount of power supplied to the first load to be increased based on the acquired amount of power.

The power control device 100 may control the power supplied to the first load to be increased for the certain time C. Here, the certain time may be the same as the certain time when the output of the first load L1 is controlled to be decreased.

For example, when controlling the output of the first load to be decreased by 20% from the target amount of output for the certain time in response to the generation of the peak power, the power control device 100 may control the output of the first load to be increased by 20% from the target amount of output for the certain time.

As shown in FIG. 11C, the power control device 100 may divide the total amount of power of the vehicle while minimizing the amount of peak power by controlling the output of the first load in response to the generation of the peak power.

Another example in which the output of the first load is controlled will be described.

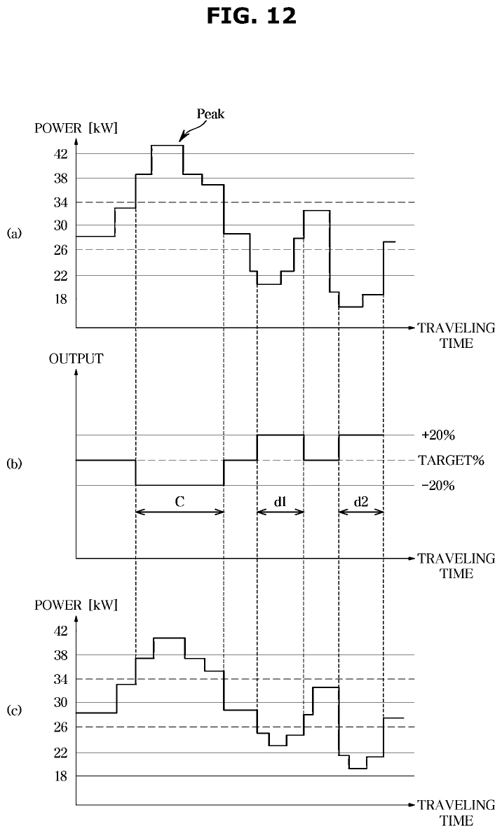

FIG. 12A is a graph showing the total amount of power of the vehicle when the output of the first load is not controlled in response to the generation of the peak power.

FIG. 12B is a graph in which the output of the first load is controlled in response to the generation of the peak power.

FIG. 12C is a graph showing the total amount of power of the vehicle when the output of the first load is controlled in response to the generation of the peak power.

As shown in FIG. 12A, the power control device 100 may confirm that the number of increase control sections is two and the time when the increase control section is formed is shorter than the certain time.

As shown in FIG. 12B, the power control device 100 may subtract the preset decrease Od from the target amount of output of the first load L1 in the decrease control section and control the operation of the first load L1 based on the subtracted amount of output.

The power control device 100 may acquire the amount of power corresponding to the subtracted amount of output and control the power supplied to the first load L1 to be decreased based on the acquired amount of power.

The power control device 100 may confirm the certain time when the peak section is formed (i.e., the decrease control section) and control the power supplied to the first load to be decreased for the confirmed certain time C.

As shown in FIG. 12B, the power control device 100 may change the amount of output of the first load to the target amount of output when the certain time C elapses and control the operation of the first load based on the changed target amount of output.

The power control device 100 may acquire the target amount of power corresponding to the target amount of output and control the power supplied to the first load L1 to be returned based on the acquired target amount of power.

The power control device 100 may control the power supplied to the first load L1 to be returned for the set time. Here, the set time may be a time shorter than the certain time and may vary depending on the certain time and the number of increase control sections.

As shown in FIG. 12B, when the set time elapses, the power control device 100 may acquire the amount of output of the first load L1 by summing the target amount of output and the preset increase Oi and control the operation of the first load L1 based on the acquired amount of output.

The increase Oi may correspond to the decrease.

The power control device 100 may acquire the amount of power corresponding to the amount of output acquired in a first increase control section d1 and control the amount of power supplied to the first load to be increased based on the acquired amount of power.

The power control device 100 may control the power supplied to the first load L1 to be increased in the first increase control section d1. Here, the first increase control section may be for half of the certain time.

When the time corresponding to the first increase control section d1 elapses, the power control device 100 may change the amount of output of the first load to the target amount of output and control the operation of the first load based on the changed target amount of output.

The power control device 100 may acquire the target amount of power corresponding to the target amount of output and control the power supplied to the first load to be returned based on the acquired target amount of power.

The power control device 100 may control the power supplied to the first load L1 to be returned for the set time.

When the set time elapses, the power control device 100 may control the operation of the first load L1 based on the amount of output obtained by summing the target amount of output and the preset increase Oi.

The increase Oi may correspond to the decrease.

The power control device 100 may acquire the amount of power corresponding to the amount of output acquired in a second increase control section d2 and control the amount of power supplied to the first load L1 to be increased based on the acquired amount of power.

The power control device 100 may control the power supplied to the first load L1 to be increased in the second increase control section d2. Here, the first increase control section d1 may be for half of the certain time.

When the time corresponding to the second increase control section d1 elapses, the power control device 100 may change the amount of output of the first load to the target amount of output and control the operation of the first load based on the changed target amount of output.

As shown in FIG. 12B, when the set time elapses, the power control device 100 may acquire the amount of output of the first load L1 by summing the target amount of output and the preset increase Oi and control the operation of the first load L1 based on the acquired amount of output.

For example, when controlling the output of the first load to be decreased by 20% from the target amount of output for the certain time in response to the generation of the peak power, the power control device 100 may control the output of the first load to be increased by 20% from the target amount of output in the first increase control section and control the output of the first load to be increased by 20% from the target amount of output in the second increase control section.

As shown in FIG. 12C, the power control device 100 may divide the total amount of power of the vehicle while minimizing the amount of peak power by controlling the output of the first load in response to the generation of the peak power.

Another example in which the output of the first load is controlled will be described.

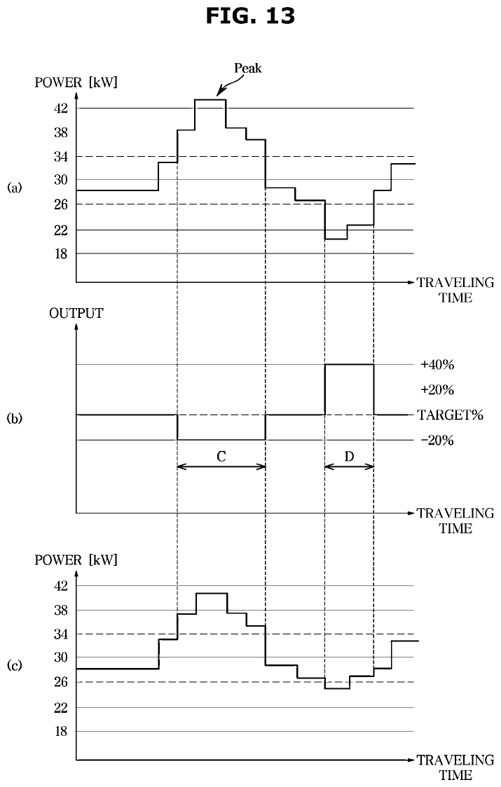

FIG. 13A is a graph showing the total amount of power of the vehicle when the output of the first load is not controlled in response to the generation of the peak power.

FIG. 13B is a graph in which the output of the first load is controlled in response to the generation of the peak power.

FIG. 13C is a graph showing the total amount of power of the vehicle when the output of the first load is controlled in response to the generation of the peak power.

As shown in FIG. 13A, the power control device 100 may confirm that the number of increase control sections is one and the time when the increase control section is formed is shorter than the certain time.

As shown in FIG. 13B, the power control device 100 may subtract the preset decrease Od from the target amount of output of the first load L1 in the decrease control section and control the operation of the first load L1 based on the subtracted amount of output.

The power control device 100 may acquire the amount of power corresponding to the subtracted amount of output and control the power supplied to the first load to be decreased based on the acquired amount of power.

The power control device 100 may confirm the certain time when the peak section is formed (i.e., the decrease control section) and control the power supplied to the first load to be decreased for the confirmed certain time C.

As shown in FIG. 13B, the power control device 100 may change the amount of output of the first load to the target amount of output when the certain time C elapses and control the operation of the first load based on the changed target amount of output.

The power control device 100 may acquire the target amount of power corresponding to the target amount of output and control the power supplied to the first load L1 to be returned based on the acquired target amount of power.

The power control device 100 may control the power supplied to the first load L1 to be returned for the set time. Here, the set time may be a time shorter than the certain time and may vary depending on the certain time and the number of increase control sections.

As shown in FIG. 13B, when the set time elapses, the power control device 100 may sum the target amount of output and the preset increase Oi, acquire the amount of output corresponding to twice the summed amount of output, and control the operation of the first load L1 based on the acquired amount of output.

The power control device 100 may acquire the amount of power corresponding to the amount of output acquired in an increase control section D and control the amount of power supplied to the first load L1 to be increased based on the acquired amount of power.

The power control device 100 may control the power supplied to the first load to be increased in the increase control section D. Here, the increase control section may be half of the certain time.

When the time corresponding to the first increase control section d1 elapses, the power control device 100 may change the amount of output of the first load to the target amount of output and control the operation of the first load based on the changed target amount of output.

The power control device 100 may acquire the target amount of power corresponding to the target amount of output and control the power supplied to the first load to be returned based on the acquired target amount of power.

For example, when controlling the output of the first load to be decreased by 20% from the target amount of output for the certain time in response to the generation of the peak power, the power control device 100 may control the output of the first load L1 to be increased by 40% from the target amount of output in the increase control section corresponding to half of the certain time.

As shown in FIG. 13C, the power control device 100 the power control device 100 may divide the total amount of power of the vehicle while minimizing the amount of peak power by controlling the output of the first load in response to the generation of the peak power.

Meanwhile, the disclosed embodiments may be implemented in the form of a recording medium configured to store instructions executable by a computer. The instructions may be stored in the form of program code and may perform the operations of the disclosed embodiments by generating a program module when executed by a processor. The recording medium may be implemented as a computer-readable recording medium.

The computer-readable recording medium includes all types of recording media in which the instructions readable by the computer are stored. For example, there may be a read only memory (ROM), a random access memory (RAM), a magnetic tape, a magnetic disk, a flash memory, an optical data storage device, and the like.

According to the present disclosure, it is possible to decrease the heat loss of a battery configured to output a high voltage and improve a traveling distance by decreasing an output of a load using the high voltage when peak power is generated.

According to the present disclosure, it is possible to stabilize a power state of a vehicle itself and improve the fuel efficiency(that is, energy efficiency) of the vehicle.

According to the present disclosure, it is possible to prevent a fault or operational abnormality of an electronic component due to a low voltage.

According to the present disclosure, it is possible to prevent traffic accidents in advance by preventing faults of drive devices, such as an engine device, a transmission device, a braking device, and a steering device, and electronic components directly associated therewith.

According to the present disclosure, it is possible to improve the merchantability of the vehicle, furthermore, enhance user satisfaction, improve user convenience and reliability, and secure the competitiveness of a product.

The disclosed embodiments have been described with reference to the accompanying drawings as described above. Those skilled in the art to which the present disclosure pertains will understand that the present disclosure may be carried out in other forms than the disclosed embodiments without changing the technical spirit or essential features of the present disclosure. The disclosed embodiments are illustrative and should not be construed as being restrictive.

What is claimed is:

1. A power control device comprising:
a communicator configured to communicate with a battery management system configured to manage a total amount of power output from a battery; and
a processor configured to receive the total amount of power through the communication unit, determine whether peak power is generated based on the received total amount of power and an amount of the peak power, and control an output of a high-voltage load based on whether the peak power is generated.

2. The power control device of claim 1, wherein in response to determination that the peak power is generated, the processor controls the high-voltage load so that the output of the high-voltage load is decreased, and in response to determination that the generation of the peak power is released, controls the high-voltage load so that the output of the high-voltage load is increased.

3. The power control device of claim 2, wherein the processor acquires a decrease of the output of the high-voltage load based on a difference between the received total amount of power and the amount of the peak power, controls the output of the high-voltage load to be decreased based on the acquired decrease in the output, acquires an increase in the output corresponding to the acquired decrease in the output, and controls the output of the high-voltage load to be increased based on the acquired increase in the output.

4. The power control device of claim 1, wherein the processor acquires a target amount of output of the high-voltage load for each traveling time based on operation information of the high-voltage load received through the communication unit, acquires a target amount of power of the high-voltage load for each traveling time corresponding to the acquired target amount of output for each traveling time, acquires a default amount of power of the high-voltage load for each traveling time based on a traveling speed received through the communication unit, and acquires a reference time for output decrease control of the high-voltage load based on the acquired target amount of power for each traveling time and the acquired default amount of power for each traveling time.

5. The power control device of claim 4, wherein the processor confirms the amount of the peak power corresponding to the traveling speed received through the communication unit.

6. The power control device of claim 4, wherein the processor controls the high-voltage load so that the output of the high-voltage load is increased based on the acquired reference time.

7. The power control device of claim 1, wherein the high-voltage load includes at least one of a compressor of a heating/ventilation/air conditioning (HVAC) device or a heater of the HVAC device.

8. A power control device comprising:
a communication unit; and
a processor configured to acquire a target amount of output of a high-voltage load for each traveling time based on operation information of the high-voltage load received through the communication unit,
acquire a target amount of power for each traveling time corresponding to the acquired target amount of output for each traveling time,
confirm an amount of peak power corresponding to a traveling speed received through the communicator and a default amount of power for each traveling time,
predict a total amount of power based on the target amount of power for each traveling time and the default amount of power for each traveling time, determine whether the peak power is generated based on the predicted total amount of power and the confirmed amount of peak power,
in response to determination that the peak power is generated, control the high-voltage load so that an output of the high-voltage load is decreased, and
in response to determination that generation of the peak power is released, control the high-voltage load so that the output of the high-voltage load is increased.

9. The power control device of claim 8, wherein the processor acquires a first reference time and a second reference time based on the predicted total amount of power for each traveling time and the confirmed amount of peak power, controls the high-voltage load so that the output of the high-voltage load is decreased for the first reference time, and controls the high-voltage load so that the output of the high-voltage load reaches a target output for the second reference time when the first reference time elapses.

10. The power control device of claim 9, wherein the processor controls the high-voltage load so that the output of the high-voltage load is increased for the first reference time when the second reference time elapses.

11. The power control device of claim 9, wherein the processor confirms the total amount of power at a time point when the peak power is generated,
acquires a decrease in the output of the high-voltage load based on a difference between the confirmed total amount of power and the amount of peak power, and
controls the output of the high-voltage load to be decreased based on the acquired decrease in the output.

12. The power control device of claim 11, wherein the processor acquires an increase in the output corresponding to the acquired decrease in the output, and controls the output of the high-voltage load to be increased based on the acquired increase in the output.

13. The power control device of claim 12, wherein the processor confirms a time period in which the predicted total amount of power for each traveling time is smaller than a reference amount of power, acquires the confirmed time period as an increase control section, and controls the high-voltage load so that the output of the high-voltage load is increased in the increase control section.

14. The power control device of claim 13, wherein the processor confirms a number of time periods in which the predicted total amount of power for each traveling time is smaller than the reference amount of power, and controls the high-voltage load so that the output of the high-voltage load is increased based on the confirmed number of time periods and the acquired increase in the output.

15. The power control device of claim 8, wherein the processor confirms a time for which the predicted total amount of power is maintained to be greater than or equal to the amount of peak power, and determines that the peak power is generated when the confirmed time is longer than or equal to a preset time.

16. A vehicle including a power control device, comprising:
a battery;
a load configured to receive a voltage higher than or equal to a preset voltage from the battery;
a controller configured to control an operation of the load;
a battery management system configured to monitor a total amount of power output from the battery; and
a power control device configured to determine whether peak power is generated based on the total amount of power and an amount of the peak power of the load, transmit output decrease control information of the load to the controller in response to determination that the peak power is generated, and transmit output increase control information of the load to the controller in response to determination that generation of the peak power is released.

17. The vehicle of claim 16, wherein the power control device acquires a decrease and an increase in the output of the load based on a difference between the total amount of power and the amount of peak power, and transmits the acquired decrease and increase in the output to the controller.

18. The vehicle of claim 17, further comprising:
a speed sensor detects a traveling speed; and
an input device,
wherein the power control device acquires a target amount of output of the load for each traveling time based on operation information of the load received in the input device, acquires a target amount of power of the load for each traveling time corresponding to the acquired target amount of output for each traveling time, acquires a default amount of power for each traveling time based on the traveling speed, and acquires a reference time when the output of the load is controlled based on the acquired target amount of power for each traveling time and the acquired default amount of power for each traveling time.

19. The vehicle of claim 18, wherein the power control device predicts the total amount of power for each traveling time based on the acquired target amount of power for each traveling time and the acquired default amount of power for each traveling time, confirms a time period in which the predicted total amount of power for each traveling time is smaller than a reference amount of power, acquires the confirmed time period as an increase control section, and transmits information on the increase control section to the controller.

20. The vehicle of claim 19, wherein the power control device confirms a number of time periods in which the predicted total amount of power for each traveling time is smaller than the reference amount of power, and transmits the confirmed number of time periods and information on the acquired increase in the output to the controller.
